(19) United States
(12) Patent Application Publication
(10) Pub. No.: US 2026/0240274 A1
(43) Pub. Date: Aug. 20, 2026

(54) HARDHAT WITH LIGHTPIPE SYSTEM

(71) Applicant: Cygnus Safety Products LLC, Salem, UT (US)

(72) Inventor: Michael D. Moore, Salem, UT (US)

(21) Appl. No.: 18/445,684

(22) Filed: Jan. 29, 2025

(51) Int. Cl. A42B 3/04; A42B 3/14; F21V 21/084; F21V 23/00; F21V 23/02; F21V 29/70

(52) U.S. Cl. CPC A42B 3/0446; A42B 3/145; F21V 21/084; F21V 23/003; F21V 23/02; F21V 29/70

(57) ABSTRACT

A hardhat with a lighting system, the hardhat comprising a crown that is generally semi-spherical shaped terminating downwardly with a peripheral edge in a generally horizontal plane, and a brim extending outwardly from the peripheral edge of the crown. An electrical circuit is coupled to the brim having components including: an LED or other lightpipe mounted underneath and around the periphery of the brim, a battery, and a power button. The LED or other lightpipe is comprised of individual lights mounted in spaced-apart positions. The lightpipe is provided not necessarily for illumination of the workspace around the user, but for identification, and communication with other workers. For example, the lightpipe may be configured to allow a user to adjust illumination color, brightness level, and constant versus intermittent illumination. Selection of such variables allows a wearer of the hardhat to be identified as to their job responsibilities, differentiating between various workers.

### TECHNICAL FIELD

The present specification relates to protective head gear, more specifically to hardhats with lights for visual safety.

### BACKGROUND

Hats with a hard outer shell separated from the head by web suspension elements are well known. They are required equipment for motorcyclists, bicyclists, firefighters, miners, garbage collection workers, construction workers and any industrial workers in many areas.

Cardoso, U.S. Pat. No. 8,117,676, discloses a hardhat with a headlamp where individual lights are activated, and in a distress operating mode wherein the individual lights are red in color and set to blinking, and in an emergency mode wherein a loudspeaker and radio distress beacon are activated.

Workers in darker environments, such as unilluminated buildings, mines and waste treatment plants sometimes use removable headlamps to assist them, but the headlamp is not helpful if it is forgotten, is removed, or is broken off of the hardhat. In addition, when working on a construction team or within a plant that requires individuals to be assigned to different operations of the job, an individual or set of lights that are used only for lighting and emergency situations are not feasible when the lights are one color and only pointing forward relative to the individual. Existing solutions include headlamps that removably attach to the helmet pointing forward, or the light can be attached to the helmet, but only shows or blinks in one color, such as red, in emergency situations. In other situations, visual safety is critical for keeping accidents from happening in a plant or job site. For example, in areas that require multiple team members to work together, such as line workers, supervisors, emergency personnel, mechanics and drivers, having different colors for different team member types allows individuals to quickly identify who is who within the plant or job site.

Therefore, there is a need for a hardhat that allows individuals to visually communicate with each other quickly, including visual indication of job competencies in a large industrial work environment.

### SUMMARY

An embodiment of the disclosure includes a hardhat with a lighting system comprising a crown that is generally semi-spherical shaped terminating downwardly with a peripheral edge in a generally horizontal plane. A brim extends outwardly from the peripheral edge of the crown. An electrical circuit can be coupled to the brim having components including an LED or other light source lightpipe mounted underneath and/or around the periphery of the brim. A battery and a power button may also be provided. The LED lightpipe can be comprised of individual lights mounted in spaced-apart positions. The LED lightpipe may be integral with the brim (i.e., non-removable). The lightpipe can have at least one brightness level and the hardhat may further comprise a control for the brightness level. The brightness level may be set to one of a first brightness level, a second brightness level, a third brightness level, a fourth brightness level, a fifth brightness level, a sixth brightness level, and/or a seventh brightness level. More or less than 7 brightness levels may be provided. In an embodiment, the control for the brightness level can be a manual control located on the brim of the hardhat. The lightpipe is configured to illuminate in at least one color and the hardhat may further comprise a control for color selection (e.g., among a plurality of colors). Where available, in an embodiment, the control for the illumination color may be a manual control located on the brim. In an embodiment, only a single color (e.g., white, or any other color) may be provided.

Selectable colors can include at least one of white, red, yellow, blue, orange, green, and/or purple. Other colors are of course also possible. The hardhat can have at least one pulse frequency level associated with the lightpipe, and the hardhat may further comprise a control for the pulse frequency level. The control to adjust pulse frequency level can be a manual control located on the brim. The pulse frequency level may allow the user to select between at least one of constant illumination, slow intermittent illumination, medium intermittent illumination, and fast intermittent illumination. The battery can be rechargeable and integral with the hardhat. A battery indicator light can be integral with the brim. The hardhat can further comprise a battery charging port that is integral with the brim. The brim can further comprise at least one visor grip panel. The hardhat can have an aluminum or other material heat sink.

The hardhat can further comprise an adjustable comfort system. The comfort system can comprise a forehead pad, a harness webbing, a top head pad, a harness rear member (e.g., plastic), at least one adjustable housing part, and a knob dial. The hardhat can be formed from high-density polyethylene, carbon fiber and a resin (e.g., epoxy), or any other suitable material. The hardhat can further comprise a spot lamp. In an embodiment, the provided lightpipe is not for illumination of a workspace around the worker wearing the hat, but is for identification, and communication of job type and assignment, as described herein. The spot lamp, where included, may provide workspace illumination. The hardhat and materials thereof may meet a particular ingress protection code level. By way of example, an embodiment may meet a IP code level of IP65, or IPX5, or IP68, providing all-weather water resistance. Those of ordinary skill in the art will appreciate the details of the IP code and standards, which are herein incorporated by reference. It will be appreciated that the particular IP level met may depend on the intended use of the hardhat. For example, a hardhat intended for use by construction workers, electrical linemen, miners, or others may meet a given code. A hardhat intended for use by more specialized workers, e.g., firefighters, may meet a different (e.g., more stringent) code.

The hardhat system can comprise a system of communicating within a group having a plurality of subgroups and at least one situation status, the system comprising, a plurality of hardhats, each hardhat comprising a lightpipe and a mode, wherein the mode is comprised of at least one color, at least one brightness level, and at least one illumination frequency level and a designation. The designation assigns a unique mode to each unique subgroup. The designation assigns a given mode to each unique personnel position. The designation assigns a given mode to each unique situation status. Exemplary situation status levels include normal status, alert status, and emergency status. Other status levels are of course also possible.

Also disclosed is a method of communicating within a group having a plurality of subgroups, the method comprising providing a plurality of hardhats, e.g., as described herein. Each hardhat may include an identifier such as a lightpipe, as well as a designated mode. A controller is also provided, for controlling the operational mode of one or more of the hardhat lightpipe identifiers. In use, the lightpipe selectively displays at least one of a plurality of colors in at least one of a plurality of brightness levels. A mode can include at least one single color displayed, different colors displayed, constant illumination, intermittent illumination, and/or a brightness level. Any such combination of variables (color, illumination, and/or brightness level) can be manipulated to differentiate between different subgroups, within an overall group of such hardhats. A controller is provided, where the controller determines the mode of one or more hardhats, and designates a mode for a given hardhat. The controller can be a remote controller.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The term “such as” as used in this specification preceding an example or examples means including, but not limited to the recited example(s). The inventors are fully aware that they can be their own lexicographers if desired. The inventors expressly elect, as their own lexicographers, to use only the plain and ordinary meaning of terms in the specification and claims unless they clearly state otherwise and then further, expressly set forth the definition. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of molding a . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood regarding the following description, appended claims, and accompanying drawings.

FIG. 1 is an isometric front view of a hardhat with lightpipe system in accordance with one or more embodiments of the disclosure.

FIG. 2 is an isometric back view of a hardhat with lightpipe system in accordance with one or more embodiments of the disclosure.

FIG. 3 is a side view of a hardhat with lightpipe system in accordance with one or more embodiments of the disclosure.

FIG. 4 is a back view of a hardhat with lightpipe system in accordance with one or more embodiments of the disclosure.

FIG. 5 is a front view of a hardhat with lightpipe system in accordance with one or more embodiments of the disclosure.

FIG. 6 is a bottom view of a hardhat with lightpipe system in accordance with one or more embodiments of the disclosure.

FIG. 7 is a side view of a hardhat with lightpipe system in accordance with one or more embodiments of the disclosure.

FIG. 8 is a top view of a hardhat with lightpipe system in accordance with one or more embodiments of the disclosure.

### DETAILED DESCRIPTION

Workers in darker environments deal with a variety of unique challenges including seeing each worker and being able to identify a worker's team association. A hardhat with LED or other light source lightpipe is described to overcome these challenges.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

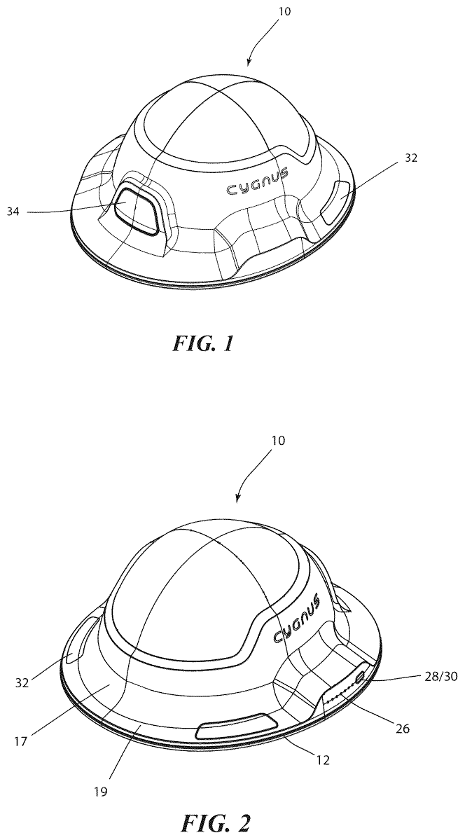

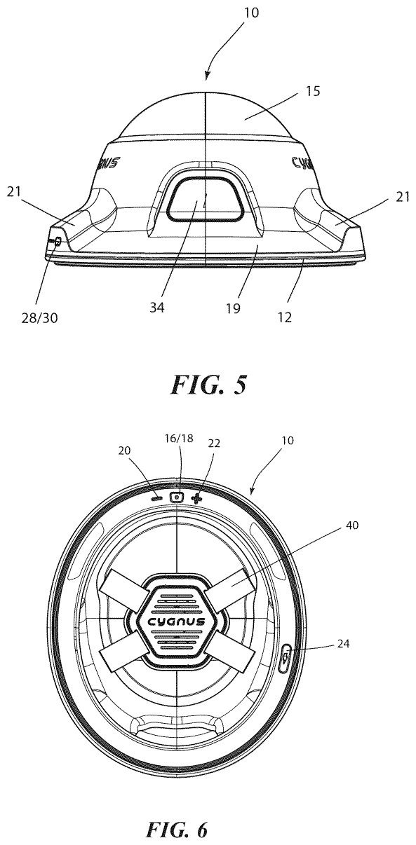

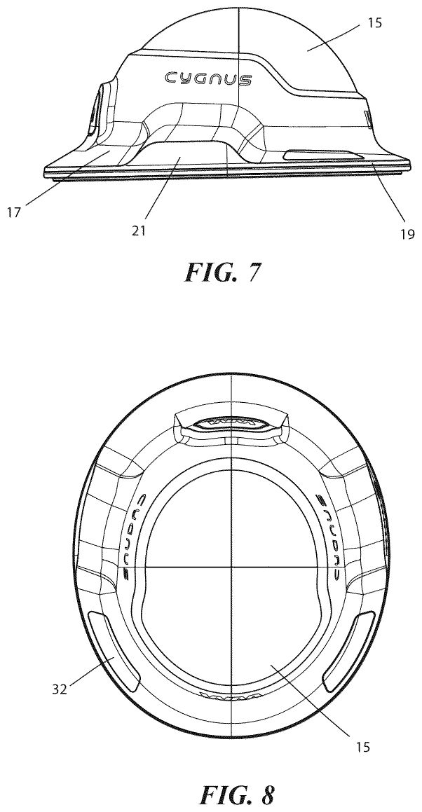

Referring to FIGS. 1-5 , a hardhat with a lighting system is shown generally at 10. The hardhat 10 can comprise a crown 15 that is generally semi-spherical shaped terminating downwardly with a peripheral edge 17 in a generally horizontal plane with a brim 19 extending outwardly from the peripheral edge of the crown. The brim 19 can be seamlessly joined integrally to the peripheral edge 17 of the crown 15 and can extend outwardly therefrom. The brim 19 can extend 360 degrees around the peripheral edge 17 wherein at least one side of the brim can have an enclosure that can extend vertical extending partially around the brim forming a compartment or enclosure 21 (FIG. 5) on at least one side of the brim.

The enclosure 21 can comprise an electrical circuit (not shown) wherein the electrical circuit can comprise a lightpipe 12, a battery, and a power button 16 (FIG. 6). The electrical circuit can be integral with the hardhat, or it can be removably positioned within the enclosure 21. The electrical circuit can be a microcontroller (“MCU”) having wireless module which can be such as, for example, Bluetooth, Wi-Fi, or the like. The electrical circuit can be coupled to the lightpipe 12, battery and the power button 16. The electrical circuit can be attached to a color adjuster control 18 (FIG. 6) wherein the color adjuster control can be such as, for example push buttons, switches, finger touch, hall effect switch or the like. The lightpipe 12 can wrap around the brim 19 a full 360 degrees and can be integral or removeable from the brim. In other embodiments the lightpipe 12 can wrap partially around the brim 19, e.g., starting from the front, back or side and rotating anywhere between 1 degree to 360 degrees. In an embodiment, the lightpipe may be intermittent (e.g., rotating around a portion of the brim 19, interrupted by a portion of the brim with no illuminating lightpipe, followed by another portion of illuminating lightpipe).

The lightpipe 12 can be an integral part of the brim 19 wherein the lightpipe is integrated into the brim, or it can be removable wherein the lightpipe can removably attached to the brim by, for example, snaps, buttons, hook and loop, magnets, or the like. The lightpipe 12 can be illuminated by any type of light source, such as, for example, a series of LEDs, a lighted flexible tube, incandescent light, fluorescent light, halogen lights, laser light, or the like. The lightpipe 12 can substantially circumvent (e.g., extend around) the brim 19 of the hardhat 10. In one or more embodiments the lightpipe 12 can include a series of LEDs mounted in spaced-apart positions that completely circumvent (e.g., extend around) the brim 19 such that the light can be seen from any angle.

The lightpipe 12 can display a single color, multiple colors, or an array of colors. The colors can be any color or color combination, such as, white, red, yellow, blue, orange, green, purple, or the like. Other colors are of course also possible. The color(s) displayed can be controlled by the color adjuster control 18. The color adjuster control 18 can be a physical button, switch, touch screen, haptic device, or the like coupled to the hardhat 10, or it can be remotely controlled by a remote device such as a remote, portable device, smartphone or other computing device. The color adjuster control 18 can be separate, or it can be integral with another control and/or controls, such as, for example the power button 16. In one or more embodiments the power button 16 could be held for a longer time to toggle the power on and/or off, and could be held for a shorter time, (e.g., tapped), to cycle through the color options.

The lightpipe 12 can be configured to illuminate with a plurality of different brightness levels which can be controlled by a brightness adjuster control 20. The brightness adjuster control 20 can be a physical button, switch, touch screen, haptic device, and/or the like coupled to the hardhat 10, or it can be remotely controlled. The brightness adjuster control 20 can be a separate control, or it can be integral with another control and/or controls, such as, for example, the power button 16. In one or more embodiments the brightness adjuster control 20 may include two buttons, e.g., a plus button for increasing the brightness level, and a minus button for decreasing the brightness level. In one or more embodiments the lightpipe may have any number of brightness levels, and in a particular embodiment at least five brightness levels. In other embodiments the lightpipe 12 could have at least seven brightness levels.

The lightpipe 12 can be configured to illuminate with at least one pulse frequency level. The pulse frequency level can be constant illumination, intermittent illumination, and/or the like. The intermittent illumination may be offered within a plurality of speeds, or frequency of illumination. The pulse frequency level can be controlled by a pulse adjuster control 22. The pulse adjuster control can be a physical button, switch, touch screen, haptic device, and/or the like coupled to the hardhat, or it can be remotely controlled. The pulse adjuster control can be a separate control, or it can be integral with another control and/or controls, such as, for example, the power button 16, and/or the brightness adjuster control 20. In one or more embodiments the pulse adjuster control 22 may include two buttons, e.g., a plus button for increasing the pulse frequency level, and a minus button for decreasing the pulse frequency level.

The battery can be removable, or it can be integral with the hardhat 10. The battery can be disposable, rechargeable, solar powered, and/or the like. Preferably, the battery is a rechargeable battery integral with the hardhat 10. The hardhat 10 can further comprise a battery charge port 28 (FIG. 5), or it can be configured to be wirelessly recharged. The charge port can be any type of receiving port, such as, for example, USB, USB-C, micro-USB, or the like. The hardhat 10 can further comprise a charge port flap 30 to help protect the port.

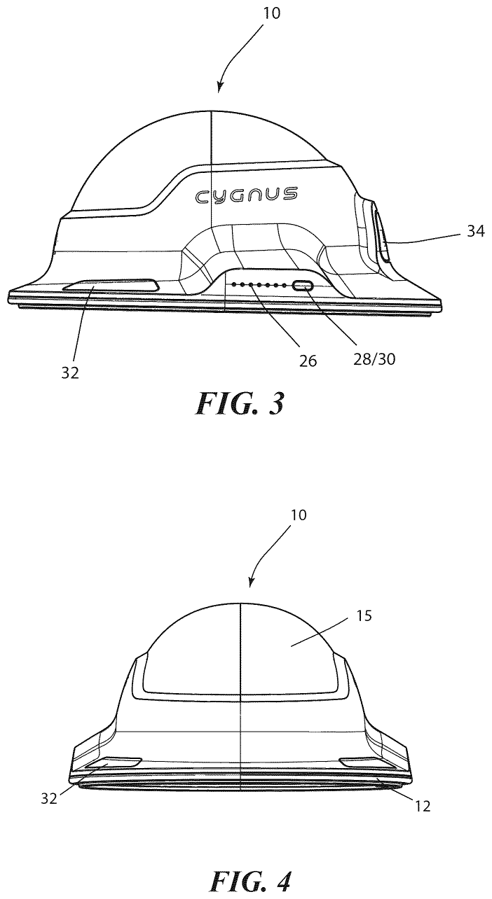

In one or more embodiments the hardhat comprises a battery indicator. The battery indicator can include a button 24 (FIG. 6) and/or lights 26 (FIGS. 2-3). The battery indicator button 24 can be a physical button, switch, touch screen, haptic device, or the like coupled to the hardhat 10, or it can be remotely controlled. The battery indicator button 24 can be a separate control, or it can be integral with another control and/or controls, such as, for example, the power button 16, or other control. The battery indicator lights 26, can include one or more lights to communicate the charge status of the battery. The battery indicator lights 26 can comprise at least seven LEDs, or include any number of indicator lights. The battery indicator button 24 can be pressed and the plurality of LEDs would light, or not, to indicate the percentage of battery charge, where 0% charge would show no lamps lit, and 100% charge would show all lamps lit. The battery indicator lights 26 can light from left to right as the charge increases or in other embodiments right to left, or some other configuration. The battery indicator lights 26 may display for at least 30 seconds before turning off. Upon pressing of button 24, indicator lights 26 could illuminate for any other period of time, either shorter or longer than 30 seconds as desired, when checking battery strength. The battery indicator lights 26 can be integral with the hat, removable, or remote. In other embodiments, the battery indicator lights 26 are remotely displayed on a user portable device. The user device can be any device capable of receiving and transmitting information such as a mobile device, a smartphone, a laptop computer, other computing device and/or the like.

The power button 16 can be any means of turning on or off the power to the electrical circuit such as, for example, a physical button, switch, touch screen, haptic device, and/or the like on the hardhat, or it can be remotely controlled. The power button 16 can be a separate control, or it can be integral with another control and/or controls.

The hardhat 10 can comprise at least one visor grip panel 32 and/or brim underside grip 35 (FIGS. 2-3 and 6). The visor grip panel can be inlaid/overmolded silicone or other elastomeric material (e.g., thermoplastic elastomer, (TPE)) with a high-grip texture.

The hardhat 10 can comprise at least one aluminum or other heat sink 34 (FIG. 1). The heat sink 34 can be anodized and/or a painted sheet metal inlay. Light weight heat conductive non-metallic or composite heat sinks are also possible.

The hardhat 10 can comprise an adjustable comfort system. The adjustable comfort system 40 (FIG. 6) can comprise a forehead pad which can be made from die-cut leather, a harness front plastic member, harness webbing, top head pad, harness rear plastic member, rear inner adjust panel, adjust housing parts, and an adjust knob dial.

The hardhat 10 can further comprise an on-demand spot lamp, and be IP65, IPX5, and/or IP68 all-weather water resistant.

The hardhat 10 can facilitate the visibility of users one to another, as well as enhance communication. The hardhat 10 can have an identifier assigning a specific hat to a specific user, or group of users. The hardhat 10 can have a mode, wherein the mode is comprised of at least one color display, brightness level, and/or frequency/pulse level. Various subgroups can be assigned to different modes, allowing workers to differentiate between such subgroups easily and quickly. The subgroups could be based on at least one of personnel position, situation status, team assignment, and/or the like. Personnel position can define chain of command (supervisors, etc), job skills, positions, area of work location, emergencies, or the like. Situation status can define normal work environment conditions, emergency conditions, one or more alert condition (wherein the user is in need of assistance), and/or the like.

For example, in a group that has a team 1, and a team 2, team 1 could be designated with a mode comprised of a single yellow color displayed, a brightness level of 3, and a frequency/pulse illumination level of constant illumination. All members of team 1 could display this mode, or subgroups within team 1 could have a different mode. For example, the supervisor of team 1 could be designated to have a single yellow color displayed, a brightness of level 5, and a frequency/pulse level of slow intermittent illumination, (i.e. a brighter yellow light that flashes). Continuing with this example, team 2 could be designated with a mode comprised of a single white color displayed, a brightness level of 3, and a frequency level of constant illumination. All members of team 2 could have this mode, or subgroups within team 2 could have a different mode. For example, the supervisor of team 2 could be designated to have a single white color displayed, a brightness of level 5, and a frequency/pulse level of slow intermittent illumination. Similarly, the supervisor could be designated with a mode utilizing multiple colors. For example, the team 1 supervisor could have a mode of yellow and green color constantly illuminated, and the team 2 supervisor could have a mode of white and green color constantly illuminated.

In another example, a team could be assigned a mode comprised of a single yellow color displayed at a brightness level of 3 and a frequency level of constant illumination for a normal situation status. If the environment became unsafe the situation status could change to that of an emergency situation status. The team could manually or automatically change the hardhat to the mode of a flashing bright red light. This change could be implemented by the individual users or done remotely by one or more users. When done by the individual user, this mode could communicate the emergency situation to those around them, indicate the need for immediate help, and/or the like. When done remotely, this mode could communicate to all individuals in an area the need to vacate the area, take precautions, and/or the like.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, the disclosed subject matter is in no way limited to a particular methodology, protocol, and/or reagent, etc., described herein. As such, various modifications, or changes to, or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

1. A hardhat with a lighting system comprising:
a crown that is generally semi-spherical shaped terminating downwardly with a peripheral edge in a generally horizontal plane;
a brim extending outwardly from the peripheral edge of the crown; and
an electrical circuit coupled to the brim having components including: an LED or other lightpipe mounted underneath and around the periphery of the brim, a battery, and a power button.

2. The hardhat of claim 1, wherein the LED or other lightpipe is comprised of individual lights mounted in spaced-apart positions.

3. The hardhat of claim 1, wherein the LED or other lightpipe is integral with the brim.

4. The hardhat of claim 1, wherein the lightpipe has at least one brightness level and the hardhat further comprises a control for the brightness level.

5. The hardhat of claim 4, wherein the brightness level provides up to five, or up to seven brightness levels.

6. The hardhat of claim 4, wherein the control for the brightness level is a manual control coupled to the brim.

7. The hardhat of claim 1, wherein the lightpipe has at least one illumination color and the hardhat further comprises a control for the color.

8. The hardhat of claim 7, wherein the control for the illumination color is a manual control coupled to the brim.

9. The hardhat of claim 7, wherein the illumination colors include at least one of white, red, yellow, blue, orange, green or purple.

10. The hardhat of claim 1, wherein the lightpipe is configured to provide at least one pulse frequency level upon illumination, and the hardhat further comprises a control for the pulse frequency level.

11. The hardhat of claim 10, wherein the control for the pulse frequency level is a manual control coupled to the brim.

12. The hardhat of claim 10, wherein the pulse frequency level control allows a user to select between at least one of constant illumination, slow intermittent illumination, medium intermittent illumination, and/or fast intermittent illumination.

13. The hardhat of claim 1, wherein the battery is rechargeable and integral with the hat.

14. The hardhat of claim 1, further comprising at least one battery indicator light, wherein the at least one battery indicator light is integral with the brim.

15. (canceled)

16. The hardhat of claim 1, further comprising a battery charge port that is integral with the brim.

17. (canceled)

18. The hardhat of claim 1, further comprising a heat sink.

19. The hardhat of claim 1, further comprising an adjustable comfort system, wherein the adjustable comfort system comprises a forehead pad, a harness webbing, a top head pad, a harness rear member, at least one adjustable housing part, and a knob dial.

20. (canceled)

21. (canceled)

22. (canceled)

23. (canceled)

24. (canceled)

25. (canceled)

26. (canceled)

27. (canceled)

28. (canceled)

29. A method of communicating within a group having a plurality of subgroups, the method comprising:
providing a plurality of hardhats, each hardhat comprising;
an identifier;
a lightpipe, wherein the lightpipe displays at least one of a plurality of colors in at least one of a plurality of brightness levels;
a mode, wherein the mode can be selected between at least one of: a single color displayed, different colors displayed, constant illumination, intermittent illumination, and/or a brightness level;
providing a controller, wherein the controller determines the mode of a hardhat within the plurality of hardhats, and designating a given mode to a hardhat within the plurality of hardhats.

30. (canceled)

31. A hardhat with a lighting system comprising:
a crown that is generally semi-spherical shaped terminating downwardly with a peripheral edge in a generally horizontal plane;
a brim extending outwardly from the peripheral edge of the crown; and
an electrical circuit coupled to the brim having components including: an LED or other lightpipe mounted underneath and/or around the periphery of the brim, a battery, and a power button;
wherein the lightpipe has at least one brightness level and the hardhat further comprises a control for selecting the brightness level for the lightpipe;
wherein the lightpipe is configured to provide at least one pulse frequency level upon illumination, wherein the hardhat further comprises a control for selecting between at least two different settings for the pulse frequency level.

32. The hardhat of claim 31, wherein the at least two different settings for the pulse frequency level include a constant illumination setting, and an intermittent illumination setting.
